(19) United States
(12) Patent Application Publication
(10) Pub. No.: US 2026/0145105 A1
(43) Pub. Date: May 28, 2026

(54) Filtering Apparatus

(71) Applicant: Maag Germany GmbH, Grossostheim (DE)

(72) Inventor: Christian Lebert, Hausen (DE)

(21) Appl. No.: 19/216,136

(22) Filed: May 22, 2025

(30) Foreign Application Priority Data
May 27, 2024 (DE) 10 2024 114 802.0

(51) Int. Cl. B01D 35/16; B01D 29/96; B01D 35/30

(52) U.S. Cl. CPC B01D 35/16; B01D 29/96; B01D 35/30; B01D 2201/302

(57) ABSTRACT

A filtering apparatus for filtering a plastic melt. A filter pin is received in an axially displaceable and rotatable manner in a pin receptacle of a housing. The filter pin has a filtering device which, in an operating position of the filter pin, is arranged between inlet and outlet channels of the housing and connects the inlet channel to the outlet channel, as well as a discharge channel, which, in a starting position of the filter pin, is flow-connected to the inlet channel and leads past the filtering device to a discharge outlet of the filter pin. An inlet port of the discharge channel in the operating position of the filter pin is rotationally offset relative to the inlet channel of the housing and, the inlet port of the discharge channel in the starting position of the filter pin is arranged so as to overlap with the inlet channel.

### CROSS-REFERENCE TO RELATED APPLICATIONS

This application claims benefit under 35 USC § 119 of DE Application No. 10 2024 114 802.0 filed 27 May 2024, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention generally relates to filtering, and more particularly to a filtering apparatus for filtering a plastic melt. The filtering apparatus can comprise a housing which has an inlet channel and an outlet channel for the melt, and a filter pin which is arranged between the inlet and outlet channels and is received in an axially displaceable and rotatable manner in a pin receptacle of the housing, wherein the filter pin has a filter portion with a filtering device, which, in an operating position of the filter pin, is arranged between the inlet and outlet channels and connects the inlet and outlet channels to one another, and a discharge channel which, in a starting position of the filter pin, is flow-connected to the inlet channel and leads past the filtering device towards the discharge outlet of the filter pin

### 2. Description of Related Art

Such filtering apparatus for filtering a plastic melt is usually referred to in the art as a screen changer, since the filter pin, which is movably guided in the housing, can be pushed out of the housing to a filter change position in which the filtering apparatus is freely accessible or protrudes out of the housing to such an extent that the filtering apparatus can be changed, cf. protrudes from the housing to such an extent that the filtering device can be changed, cf. for example DE 10 2010 025 163 A1 or DE 20 2010 017 247 U1 , or DE 10 2012 006 563 B3 , DE 10 2006 050 683 A1 and DE 195 09 059 C1 . In order to be able in this case to move the system continuously, two or more filter pins, each with a filtering device, can be movably received in the housing and in their operating positions each create a path for the fluid to be filtered from the inlet channel of the housing to the outlet channel. If one of the filter pins is moved to the filter change position, the fluid still has to pass through at least one other filter pin or its filtering device, which remains in the operating position, in order to pass from the inlet side to the outlet side. To make it easier to remove or change the filters, the pins can also be rotated when moving out of the housing into the filter change position, e.g., via a sliding guide, cf. DE 10 2014 016 634 A1 .

The filter pins are in this case guided in their respective pin receptacle in the housing with virtually no play or are fluid-tight to such an extent that the plastic melt can only cross the pin receptacle if the filter portion of the pin fits between the inlet and outlet channels in the operating position and the plastic melt cannot push through between adjacent pin portions and the pin receptacle wall.

The filtering apparatus is often used to remove unwanted foreign particles from melted plastic, for example in the form of a polymer melt, by means of filtration, as such foreign particles would lead to incorrect production or a loss of quality. These filtering apparatuses have become increasingly important in the recycling of thermoplastics.

Depending on the degree of contamination of the respective fluid or plastic to be filtered, the service life of the filters used for this purpose changes, so that the filter must be cleaned or renewed either by backwashing or by replacement as the degree of contamination increases.

In addition, the screen changers can also be used to conduct away the still defective melt during the start-up of a production cycle or a plastic batch before it is fed into a downstream processing system such as a pelletizer. When the process is started up, the melt often does not yet have the required temperature, or, for example, during a color change, contamination or residues of different colored material may still remain in the channels of the system, so that the initially inflowing material is not yet usable and may also clog the filters of the screen changer. Depending on the size of the system, sometimes considerable quantities of material of up to half a ton or even a whole ton are conducted away as rejects before the melt suitable for further processing can be fed through the filtering device to the down-stream further processing system.

Discharging the material during the start-up process can be accomplished by special start-up valves, which can be used in particular upstream or possibly also downstream of the screen changer in order to conduct away unsuitable material, for example to let it run or drip onto the floor or collect it in a collecting vessel.

In order to avoid such separate start-up valves, it has also been suggested that the screen changers themselves be used to discharge the material during the start-up process. For this purpose, for example, the filter pin can be pulled into or out of the housing to such an extent that the filter pin blocks the pin receptacle on one side of the inlet channel, but on the other hand the inlet channel leads into the pin receptacle without obstruction by the filter pin and accordingly incoming melt can flow into the pin receptacle, collect there and run out of the pin receptacle of the housing on the unblocked side. If the filter pin is moved back to its operating position, the filter pin clears the start-up material still in the pin receptacle out of the pin receptacle. However, the plastic melt that runs freely into the housing or collects in the pin receptacle results in contamination of the screen changer and often also in increased wear, as corked plastic components, for example, can stick to the housing and then have to be torn off when the filter pin is pushed back. In addition, the axial drive requires a long range of adjustment and therefore a long overall length in order to be able to move the filter pin out of the housing to one side in the filter change position on the one hand and to be able to move the filter pin back beyond the operating position in the opposite direction for initial discharge during start-up on the other.

To discharge the material during the start-up phase, it has also already been proposed to provide a special discharge channel in the filter pin and to move the filter pin into a start-up position in which the discharge channel with a peripheral inlet opening is aligned with the housing-side inlet channel and the filter pin protrudes a little from the housing, so that the discharge outlet of the discharge channel provided there is outside the housing and the material or fluid no longer contaminates the housing, but can drip directly from the filter pin onto the floor.

The patent document DE 10 2014 009 768 B4 shows such a screen changer with a filter pin that can fulfill this drainage function. The discharge channel extends through a central web which passes axially through the filtering chamber of the filter pin, so that the discharge channel is guided past the filtering device as if through a tube, in order to guide plastic melt received from the inlet channel of the housing past the filtering device of the pin to the end face of the pin protruding from the housing, from which the plastic melt can then drip onto the floor.

Since the filter device of the pin usually requires a sufficient flow cross-section and is sometimes longer on the inlet side than the inlet channel in the housing in order to enable the material to be filtered to be distributed on the filter, the inlet port of the discharge channel is arranged axially offset relatively far from the inlet channel of the housing, so that the filter pin must be adjusted quite far overall in order to bring the inlet port of the discharge channel into alignment with the inlet channel on the housing side. As a result, the apparatus is quite large in the axial direction. On the other hand, the tightness between the filter pin and the pin receptacle is quite difficult, especially in the region around the inlet channel, as the back pressure in front of the filter device increases here, so that the circumferential wall of the filter pin around the filtering device requires a certain amount of space in order to ensure the tightness of the filter pin against the pin receptacle.

In view of the above background, it is the underlying object of the present invention to provide an improved filtering apparatus of the type which avoids the disadvantages of the prior art and advantageously improves on the latter. In particular, the compact design of the filtering apparatus should allow material that is unsuitable for further processing to be easily and reliably discharged past the filtering device, for example during a start-up process, without causing contamination and wear in the screen changer or even requiring separate start-up valves.

### BRIEF SUMMARY OF THE INVENTION

In an exemplary embodiment of the present invention, a filtering apparatus comprises a housing comprising an inlet channel, and a pin receptacle, and a filter pin comprising a discharge channel having an inlet port located on an outer circumference of the filter pin and configured to lie in a circumferential sector of the filter pin, wherein the filter pin is configured to be received in an axially displaceable and rotatable manner in the pin receptacle of the housing, the filter pin is further configured to assume different rotational positions in the pin receptacle of the housing, including an operating position and a starting position, in the operating position of the filter pin, the inlet port of the discharge channel of the filter pin is rotationally offset relative to the inlet channel of the housing, and in the starting position of the filter pin, the inlet port of the discharge channel of the filter pin is arranged so as to overlap with the inlet channel of the housing.

In any exemplary embodiment, the housing can further comprise an outlet channel.

In any exemplary embodiment, the filter pin can further comprise a filter portion with a filtering device, and a discharge outlet.

In any exemplary embodiment, the filter pin can be further configured to be arranged between the inlet and outlet channels of the housing.

In any exemplary embodiment, in the operating position of the filter pin, the filtering device of the filter portion of the filter pin can be configured to be arranged between the inlet and outlet channels of the housing, and connect the inlet channel of the housing to the outlet channel of the housing, as well as the discharge channel of the filter pin

In any exemplary embodiment, in the starting position of the filter pin, the discharge channel of the filter pin can be configured to be flow-connected to the inlet channel of the housing and lead past the filtering device of the filter portion of the filter pin to the discharge outlet of the filter pin.

In any exemplary embodiment, the filtering apparatus can further comprise a rotary drive for rotating the filter pin in the pin receptacle of the housing at least one of when the filter pin is axially stationary, or independently of an axial adjustment of the filter pin.

In any exemplary embodiment, another rotational position of the filter pin in the pin receptacle of the housing can be a filter change position, in the filter change position of the filter pin, the filtering device of the filter portion of the filter pin is configured to be freely accessible for replacement and/or extended out of the housing axially, and the filter pin is further configured to assume at least approximately the same rotational position in the operating position and in the filter change position.

In another exemplary embodiment of the present invention, a filtering apparatus comprises a housing comprising an inlet channel, an outlet channel, and a pin receptacle, and a filter pin configured to be received in an axially displaceable and rotatable manner in the pin receptacle of the housing, the filter pin comprising a filter portion with a filtering device, a discharge outlet, and a discharge channel having an inlet port located on an outer circumference of the filter pin and configured to lie in a circumferential sector of the filter pin, and a rotary drive for rotating the filter pin in the pin receptacle of the housing, wherein the filter pin is further configured to be arranged between the inlet and outlet channels of the housing, and assume different rotational positions in the pin receptacle of the housing, including an operating position, a starting position, and a filter change position, in the operating position of the filter pin the filtering device of the filter portion of the filter pin is configured to be arranged between the inlet and outlet channels of the housing, the filtering device of the filter portion of the filter pin is configured to connect the inlet channel of the housing to the outlet channel of the housing, as well as the discharge channel of the filter pin, and the inlet port of the discharge channel of the filter pin is configured to be rotationally offset relative to the inlet channel of the housing, and in the starting position of the filter pin the discharge channel of the filter pin is configured to be flow-connected to the inlet channel of the housing and lead past the filtering device of the filter portion of the filter pin to the discharge outlet of the filter pin, and the inlet port of the discharge channel of the filter pin is configured to be arranged so as to overlap with the inlet channel of the housing.

In any exemplary embodiment, the rotary drive can be configured for rotating the filter pin in the pin receptacle of the housing when the filter pin is axially stationary and/or independently of an axial adjustment of the filter pin.

In any exemplary embodiment, the rotary drive can be configured so as to be uncoupled from the filter pin, wherein the filter pin is configured to be axially movable between the operating position and filter change position when uncoupled from the rotary drive.

In any exemplary embodiment, the filter pin can be configured to be coupled to the rotary drive by axial displacement of the filter pin and uncoupled from the rotary drive, in such a manner that the rotary drive is moveable into a rotary drive coupling position in the operating position of the filter pin or in the filter change position of the filter pin, and the filter pin can subsequently be moved axially into a filter pin coupling position.

In any exemplary embodiment, the rotary drive can comprise an adjustment actuator with an effective direction oriented transversely to a longitudinal axis of the filter pin and at least approximately parallel to a tangent to the filter pin, or the rotary drive and an axial drive configured for axial adjustment of the filter pin are arranged on the same side of the housing, wherein the rotary drive, viewed axially of the filter pin, is arranged between the housing and a pressure cylinder of the axial drive.

In any exemplary embodiment, in the filter change position of the filter pin, the filtering device of the filter portion of the filter pin can be configured to be freely accessible for replacement and/or extended out of the housing axially, and the filter pin is further configured to assume at least approximately the same rotational position in the operating position and in the filter change position.

In any exemplary embodiment, the starting position of the filter pin, viewed axially, can lie between the operating position and the filter change position, and an axial range of adjustment of the filter pin from the operating position into the starting position is shorter than from the starting position into the filter change position.

In any exemplary embodiment, the filter pin can be further configured to be moveable from the operating position into the filter change position and/or from the filter change position into the operating position by axial displacement without turning and/or without approaching the rotational position of the starting position.

In any exemplary embodiment, a rotational offset of the filtering pin between the operating position and the starting position can be at least one of between 20° and 120°, between 30° and 90°, or between 30° and 60°.

In any exemplary embodiment, the discharge outlet of the filter pin can be arranged in an end portion of the filter pin that protrudes from the housing when in the starting position of the filter pin.

In any exemplary embodiment, the discharge channel of the filter pin can open with the discharge outlet of the filter pin on an end face of the filter pin.

In any exemplary embodiment, in at least in the starting position of the filter pin, the discharge channel of the filter pin can be configured in a continuously sloping manner up to the discharge outlet of the filter pin.

In any exemplary embodiment, the discharge channel of the filter pin can have a cross-section that increases continuously or in steps in a discharge direction.

In any exemplary embodiment, the discharge channel of the filter pin can extend through an axial column that bridges the filter portion of the filter pin in an exposed manner.

In any exemplary embodiment, the filtering apparatus can further comprise a second filter pin configured to be axially displaceably received in a second pin receptacle in the housing, wherein the inlet and outlet channels of the housing are each configured in a bifurcated manner, so that the inlet channel of the house is selectively flow-connected to the outlet channel of the housing either individually via each respective filter pin or both filter pins together.

In any exemplary embodiment, the same side of the housing can be the side of the housing facing away from a housing side for filter replacement.

In any exemplary embodiment, in the starting position of the filter pin, the filtering device can be still arranged within the housing.

In any exemplary embodiment, the discharge channel of the filter pin can extend through the axial column that bridges the filter portion of the filter pin in the exposed manner and contains a longitudinal central axis of the filter pin.

In any exemplary embodiment, the filter pin different from the second filter pin can be a first filter pin, and the second filter pin has a second filter pin starting position in which the inlet channel of the housing is shut off from the outlet channel of the housing, and the inlet channel of the housing is flow-connected to surroundings of the housing only via the discharge channel of the first filter pin.

In any exemplary embodiment, the filtering apparatus can further comprise a control device configured for axial adjustment of the first and second filter pins in such a manner that, in order to set a filtering apparatus starting position of the filtering apparatus, the first filter pin is brought into the starting position by axial displacement and rotational adjustment, and the second filter pin is brought into the starting position solely by axial adjustment.

In another exemplary embodiment of the present invention, a filtering apparatus for filtering a plastic melt comprises a housing which has an inlet channel and an outlet channel, and a filter pin which is arranged between the inlet and outlet channels and is received in an axially displaceable and rotatable manner in a pin receptacle of the housing, wherein the filter pin has a filter portion with a filtering device which, in an operating position of the filter pin, is arranged between the inlet channel and the outlet channel and connects the inlet channel to the outlet channel, as well as a discharge channel, which, in a starting position of the filter pin, is flow-connected to the inlet channel and leads past the filtering device to a discharge outlet of the filter pin, wherein the filter pin assumes different rotational positions in the pin receptacle in the operating position, on the one hand, and the starting position, on the other hand, wherein an inlet port of the discharge channel located on the outer circumference of the filter pin lies in a circumferential sector of the filter pin which, in the operating position of the filter pin, is rotationally offset relative to the inlet channel of the housing and, in the starting position of the filter pin, is arranged so as to overlap with the inlet channel.

It is therefore suggested that the filter pin be rotated relative to its operating position in order to move it to the starting position. According to the invention, the filter pin assumes different rotational positions in the pin receptacle in the operating position on the one hand and the starting position on the other hand, wherein an inlet port of the discharge channel located on the outer circumference of the filter pin is located in a circumferential sector of the filter pin which is rotationally offset relative to the inlet channel of the housing in the operating position of the filter pin and overlaps with the inlet channel in the starting position of the filter pin. Due to the rotational positioning movement of the filter pin into the starting position and the rotational offset between the inlet of the filter device on the one hand and the inlet of the discharge channel on the other, the filter pin can be quite short in the axial direction, which enables a short positioning movement into the starting position and ultimately enables an overall compact design of the filtering apparatus. At the same time, sealing problems in the operating position between the filter pin and pin receptacle in the housing can be avoided.

In an advantageous further development of the invention, the rotational adjustment movement of the filter pin can be superimposed with an axial adjustment movement of the filter pin in order to adjust the filter pin between its operating position and its starting position. This type of combinatorial turning and shifting makes it possible to achieve reliable discharge of the melt or fluid to be discharged despite short positioning movements and a compact design. In particular, the super-imposed axial movement to move the filter pin from the operating position to the starting position can serve to move the filter pin, which can be completely or substantially flush with the housing in the operating position, a little way out of the housing to ensure that plastic melt flowing out of the discharge channel does not get caught in or on the housing, but can drip off the filter pin directly.

The starting position of the filter pin can be viewed axially between the operating position and a filter change position of the filter pin, in which the filter device of the filter pin is freely accessible or sufficiently accessible for a filter change, in particular is substantially completely extended out of the housing. In the starting position, however, the filter device can still be positioned completely or at least partially inside the filter housing, but on the other hand it can be moved away from the inlet channel of the housing to allow the fluid flowing in via the inlet channel to enter the discharge channel.

In order to be able to switch quickly from the starting position to the operating position, the axial range of adjustment of the filter pin from the operating position to the starting position can be shorter than from the starting position to the filter change position in a further development of the invention. In particular, the starting position of the filter pin can be so close to its operating position that in the starting position the filtering device of the filter pin is already or still completely arranged inside the housing.

Due to the arrangement of the start-up or discharge position between the operating position and the filter change position, the maximum range of adjustment in the axial direction can be limited to the distance between the operating position and the filter change position. In particular, it is not necessary to move the filter pin from the operating position to opposite sides in order to move once to the filter change position and the other time to the starting position, as is the case with conventional screen changers, which discharge the material into the housing in the starting position.

In a further development of the invention, it is advantageously not necessary to adjust the filter pin rotationally if the filter pin is to be moved directly from the operating position to the filter change position or, conversely, directly from the filter change position to the operating position. The filter pin can be moved directly between the operating position and the filter change position without rotational twisting, even if the starting position is overrun when viewed axially. If the filter pin is to be moved directly to the filter change position or, conversely, directly to the operating position after a filter change, it is not necessary to bring the discharge channel into alignment with the inlet channel on the housing side and the rotational actuating movement component, which is performed when moving to the starting position, can be dispensed with.

In an advantageous further development of the invention, a rotary drive for rotating the filter pin in the pin receptacle can be uncoupled from the filter pin or coupled to the filter pin in order to be able to rotate the filter pin for moving to the starting position and to be able to disengage the rotary drive or not have to adjust it when moving the filter pin directly between the starting position and the filter change position.

A releasable coupling between the rotary drive and the filter pin can advantageously comprise coupling means or coupling halves that can be engaged and disengaged in an axial direction, i.e., substantially parallel to the longitudinal axis of the filter pin. In particular, the coupling can be configured to engage and disengage by moving the filter piston axially. If the rotary drive is to be coupled in order to rotate the filter pin to move to the starting position, the rotary drive can, for example, move to a determined coupling position and then the filter pin can be moved axially into a coupling position in order to be coupled to the rotary drive and then be rotated by the rotary drive. Conversely, the filter pin can be uncoupled from the rotary drive by axial displacement, so that the rotary drive can then be moved back into a passive waiting position in which the filter pin can be moved past the axial starting position without colliding with the rotary drive.

For example, the rotary drive can comprise an adjustment actuator that has an operating direction that runs transversely to the longitudinal axis of the filter pin and can be aligned substantially parallel to a tangent to the filter pin. For example, a pressure medium actuator can be used, which can be configured as a pneumatic cylinder or hydraulic cylinder. When coupled, the adjustment actuator can act on the filter pin in the manner of a crank drive to rotate it in the pin receptacle.

In an advantageous further development of the invention, the rotary drive can be configured to rotate the filter pin in the pin receptacle when the filter pin is axially stationary and/or to rotate it independently of an axial adjustment of the filter pin. As a result, unlike with a link-type rotary control, it is not necessary to adjust the filter pin axially at the same time in order to reach a rotation. In particular, this makes it possible to only move the filter pin axially without a rotary component if, for example, the filter pin is to be moved directly from the operating position to the filter change position. Since the rotary adjustment is only operated when it is actually needed, the filtering apparatus reaches an overall low-wear operation.

In an advantageous further development of the invention, an axial drive for adjusting the filter pin in the longitudinal direction of the filter pin or in the longitudinal direction of the pin receptacle can comprise an adjustment actuator in the form of a pressure cylinder, for example a pneumatic or hydraulic cylinder, which can be arranged substantially coaxially to the filter pin on an end face of the housing. In principle, however, other axial drives would also be possible, for example in the form of a spindle motor or an adjustment actuator with an intermediate lever gear.

In order to achieve a compact design, the axial drive and the rotary drive can, in an advantageous further development of the invention, be arranged on the same side of the housing, in particular on the side of the housing opposite the filter change and/or drain side of the housing. The filter change and/or drain side of the housing refers to the side of the housing on which the filter piston is extended a little way out of the housing in order to drain the fluid to be drained off during start-up or to be able to change the filter device in the filter change position. By arranging the axial and rotary drives on the opposite side of the housing, neither the filter change is impaired nor is there a risk of the drives being contaminated by the fluid to be discharged, which drips out of the filter pin when the discharge channel is active in the starting position of the filter pin. At the same time, the filter device can be compact overall, as the axial and rotary drives can be arranged overlapping on the housing side. If the housing is viewed axially perpendicular to the longitudinal axis of the filter pin, the axial and rotary drives can be arranged to at least partially overlap each other.

Nevertheless, the rotary drive, in particular when designed in the form of a pressure cylinder, can protrude towards an adjacent housing side or be arranged there, wherein the adjacent housing side is adjacent to the housing side on which the axial drive is provided.

The rotation of the filter pin between the operating position on the one hand and the discharging starting position on the other can be relatively small, for example between 20° and 120° or between 30° and 90°, i.e. the filter pin is rotated by an angle of between 30° and 60°in order to be moved from the operating position to the starting position or to swivel the inlet port of the discharge channel into the sector in which the inlet channel opens into the pin receptacle.

The discharge channel preferably has its discharge outlet or discharge outlet in an end portion of the filter pin, which is moved out of the housing when the starting position is approached. In particular, the discharge channel can open on an end face of the filter pin so that the discharged fluid can flow out from the end face of the filter pin or drip off from there. This ensures that the fluid to be drained does not drip into the housing or contaminate the housing, but drips directly from the filter pin, even with a small axial range of adjustment between the operating position and the starting position.

In a further development of the invention, the discharge channel can be configured in a continuously sloping manner from its inlet port towards the discharge outlet, at least in the starting position of the filter pin, so that gravity helps to allow the fluid to be discharged to run out of the filter pin. For example, the discharge channel can have an inlet portion that leads from the outer circumference of the filter pin to its center and then have an axial portion that leads to an end face of the filter pin and has a sloping contour.

In a further development of the invention, the discharge channel can also have a cross-section that increases towards the discharge outlet, so that the plastic melt to be discharged has an easier time flowing out of the discharge opening and experiences a reduced flow resistance along the discharge channel.

In an advantageous further development of the invention, the discharge channel can widen conically towards the outlet opening. Such a conical contouring of the discharge channel ensures an increasing cross-section on the one hand and reaches a sloping floor on the other.

The discharge channel may extend through an axial column which bridges the filter portion of the filter pin in an exposed manner and may preferably contain a longitudinal central axis of the filter pin. The axial column can be configured in the form of a web that passes through the filtering chamber of the filter pin or through its filter portion. In particular, the filtering device may have a curved screen which may extend around the column. If the filter pin is in its operating position, the column is flowed around transversely by the filtered fluid or the fluid to be filtered when the fluid flows from the inlet side to the outlet side. The discharge channel is routed through the column.

In an advantageous further development of the invention, several adjustable filter pins can be provided in the housing to enable continuous operation. In particular, a second filter pin can be axially displaceably received in a second pin receptacle, wherein the inlet channel and the outlet channel of the housing can each be configured to be bifurcated in order to lead to both the first and the second filter pin via the bifurcation. Such a bifurcated design of the inlet channel and outlet channel allows the fluid to be filtered to flow selectively via each filter pin individually from the inlet side to the outlet side or via both filter pins together from the inlet side to the outlet side. In the event of a filter change, the material to be filtered can continue to be filtered via the at least one other filter pin remaining in the operating position and flow from the inlet side to the outlet side. If both or all filter pins are in the operating position, maximum throughput can be achieved or the fluid can then flow over all filtering devices of all filter pins via the bifurcations.

The second filter pin can have a starting position in which the inlet channel is shut off from the outlet channel and the inlet channel is only flow-connected to the surroundings of the housing via the discharge channel in the first filter pin.

Advantageously, a control device is provided which coordinates or controls the adjustment of the two filter pins or their drive devices when moving to the starting position, in particular in such a way that the first filter pin is moved to its starting position by axial displacement and rotational adjustment and the second filter pin is moved to its starting position only by axial adjustment, in which the second filter pin blocks the flow path assigned to it from the inlet side to the outlet side.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a perspective view of a filtering apparatus in the form of a screen changer with two filter pins in a filter housing, wherein both filter pins are shown in their operating position.

FIG. 2 is a perspective view of the filtering apparatus of FIG. 1, wherein one of the filter pins is shown in its filter change position for changing the filter.

FIG. 3 is a perspective view of the filtering apparatus from the foregoing figures, wherein both filter pins are in their operating position and the rotary drive for rotating the lower filter pin moves into its coupling position.

FIG. 4 is a perspective view of the filtering apparatus similar to FIG. 3, wherein the lower filter pin is moved axially into its coupling position for coupling to the rotary drive.

FIG. 5 is a perspective view of the filtering apparatus similar to FIGS. 3 and 4, wherein the rotary drive has rotated the lower filter pin in order to move into the starting position.

FIG. 6 is a perspective view of the filtering apparatus similar to FIG. 5, wherein the upper filter pin is moved into a block position in order to discharge the material to be separated only via the lower filter pin.

FIG. 7 is a perspective view of the filtering apparatus from the foregoing figures, showing the discharge of the material via the discharge channel in the lower filter pin.

FIG. 8 is a perspective view of the filtering apparatus after the start-up process, wherein the upper filter pin has moved back into its operating position.

FIG. 9 is a perspective view of the filtering apparatus similar to FIG. 8, wherein the lower filter pin has been moved back into its operational rotational position by the rotary drive.

FIG. 10 is a perspective view of the filtering apparatus similar to FIG. 9, wherein the lower filter pin is moved into its operating position and the rotary drive is uncoupled.

FIG. 11 is a perspective view of the filtering apparatus similar to FIG. 10, wherein the uncoupled rotary drive is moved back into its waiting position.

FIG. 12 is a perspective view of the filtering apparatus similar to FIG. 11, wherein the lower sieve bolt is fully retracted into its operating position.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

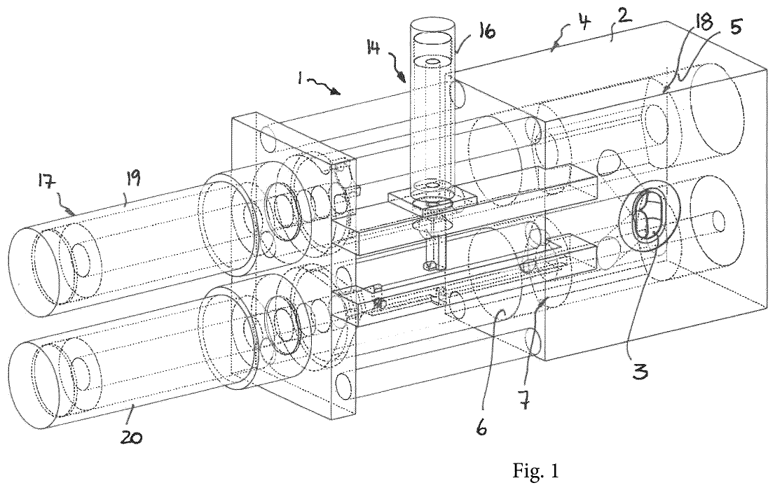

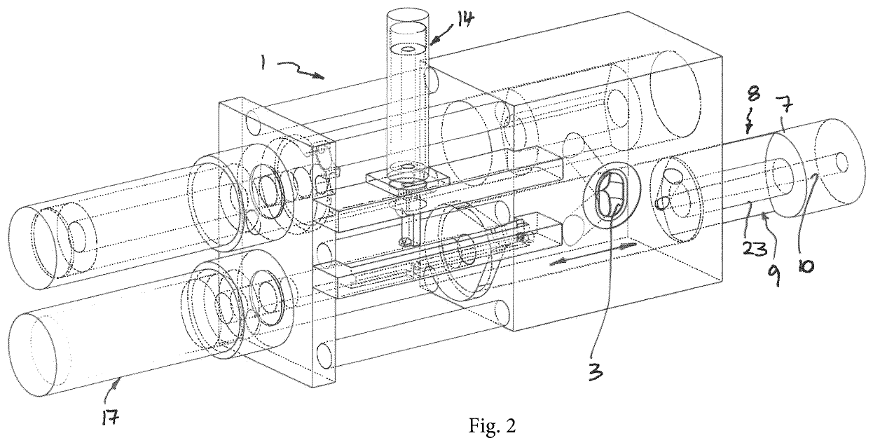

As shown in the figures, the filtering apparatus 1 can be configured as a screen changer, which can have two adjustable filter pins 7 and 18 in order to be able to work continuously. If one of the filter pins is in its filter change position in order to change the filter of the pin, cf. FIG. 2, the material to be filtered can be filtered via the other filter pin, which is still ready for operation. If both filter pins 7, 18 are in their operating position, cf. FIG. 1, the material to be filtered can be passed over both filter pins 7, 18.

The filtering apparatus 1 comprises a housing 2, in which two pin receptacles 5, 6 can be configured to slidably receive the two filter pins 7, 18, wherein at least one of the filter pins 7 can also be rotated in the associated pin receptacle 6. The two pin receptacles 5, 6 can in particular be configured in the form of cylindrical through recesses, for example in the form of bores, wherein diameter jumps can also be provided, for example by turning or similar machining.

The filter pins 7, 18 are also substantially or at least in sections cylindrical, in particular circularly cylindrical, contoured in order to fit precisely or without play and to seal against viscous molten plastic in the pin receptacles 6.

In particular, the filter pins 7 and 18 can each have two cylindrically contoured end portions, between which the filter pins 7, 18 each have a filter portion 8, which is each provided with a filter device 9, for example in the form of an arcuately curved screen, wherein plate-shaped screens or other filter packs can also be used if necessary.

In the filter portion 8, the filter pins 7 and 18 are each tapered in diameter and/or provided with transverse recesses and/or flattenings and/or tapers in order to allow the fluid to be filtered, in particular polymeric plastic melts, to flow transversely through the pin receptacle 6. Alternatively, or additionally, it is also possible to widen or specially contour the pin receptacles 6 in a region in which the filtering devices 9 of the filter pins 7 are positioned in their operating position, in order to allow flow transversely to the other side of the receptacle after passing the filtering device.

As shown in the figures, the housing 2 comprises an inlet channel 3 and an outlet channel 4, which are located or can open out on opposite sides of the housing and are each in flow connection with the two pin receptacles 5, 6 or lead transversely to the pin receptacles 5, 6. The inlet and outlet channels 3, 4 can each fork from a common orifice to lead to both pin receptacles 5, 6, cf. for example FIG. 1 and FIG. 2.

The two filter pins 7 can each be axially adjusted by an axial drive 17 in the pin receptacles 6, wherein the axial drives 17 can, for example, have two pressure cylinders 19, 20, each of which can be arranged on the end face in front of a pin receptacle 6 or the filter pin 7 received therein. The pressure cylinders 19, 20 can in particular be arranged parallel or coaxial to the longitudinal axis of the filter pin and supported or mounted on the housing 2, wherein, for example, the retractable and extendable piston rod of the respective pressure cylinders 19 and 20 can be connected to one of the filter pins 7 in order to be able to move the filter pin 7 or 18 axially in the pin receptacle 5, 6 by retracting and extending the piston rod.

As illustrated in FIG. 2, the axial drives 17 can each move the filter pins 7 and 18 to the opposite side out of the housing 2 into a filter change position in which the filtering device 9 on the filter portion 8 of the filter pin 7 is freely accessible so that it can be changed or cleaned. If, for example, one of the filter pins 7 is in the filter change position, the cylindrical end portion of the filter pin 7 remaining in the pin receptacle 6 can block the inlet channel 3, or more precisely its bifurcation leading to the pin receptacle 6, so that the fluid can only flow to the second pin receptacle 5 of the other filter pin 8 and be filtered there.

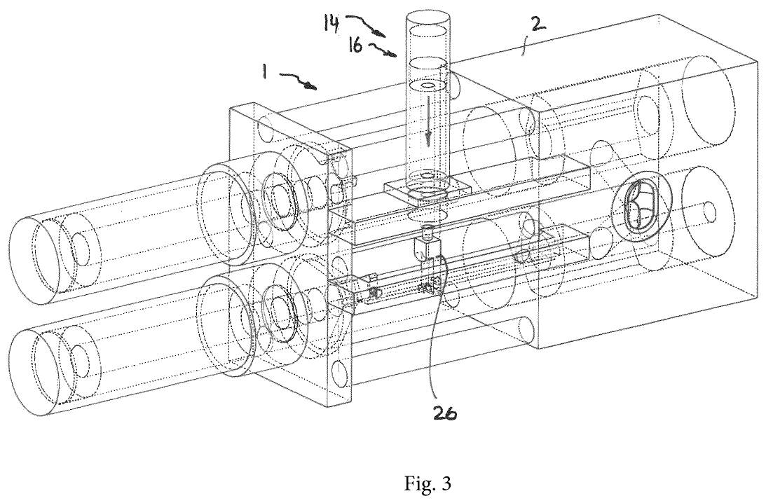

As illustrated in FIGS. 3 to 7, one of the filter pins 7, preferably a lower filter pin 7, is also provided with a discharge channel 10 in order to separate off material that cannot yet be utilized when the system starts up, as described at the beginning.

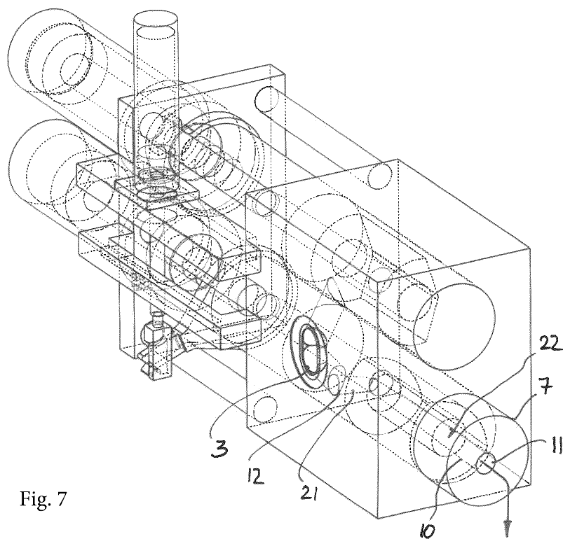

The discharge channel 10 can extend essentially axially through the filter pin 7 past the filtering device 9 and have a transverse channel portion 21 on the up-stream or inlet side that passes transversely through the pin, which has an inlet port 12 that opens on the outer circumference of the filter pin 7, in particular its cylindrical end portion, and on the other hand is connected to an axial channel portion 22 that passes centrally through the filter pin 7 in the axial direction and opens on an end face of the filter pin 7 or has a discharge outlet 11 there, cf. FIG. 7.

In particular, the discharge channel 10 extends with its axial channel portion 22 through a column 23 of the filter pin 7, which is configured in the filter portion 8 of the filter pin 7 and forms its previously described, tapered diameter region in order to allow the material to be filtered to flow transversely through the pin receptacle 6. The column 23 may include the longitudinal central axis of the filter pin 7 and may connect the two described cylindrical end portions of the filter pin 7.

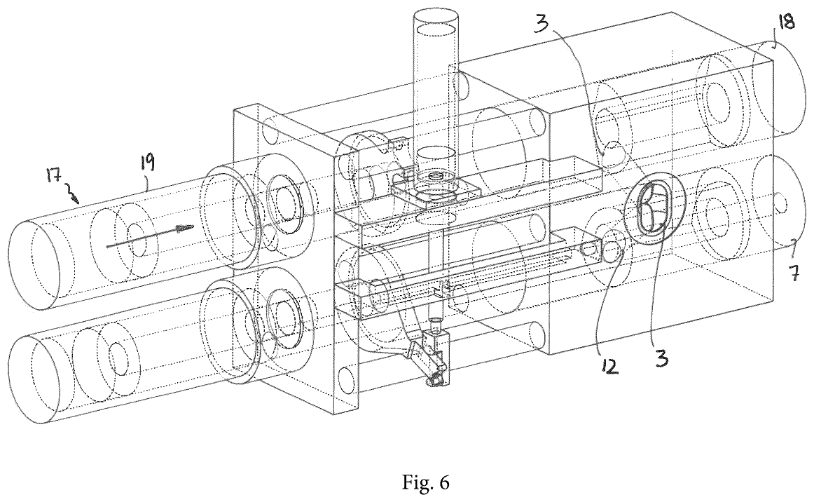

As illustrated in FIG. 6 and FIG. 7, the discharge channel 10, at least when the filter pin 7 is in its starting position, can be configured in a continuously sloping manner from the inlet port 12 towards the discharge outlet 11. Alternatively, or additionally, the discharge channel 10, at least in the region of its axial channel portion 22, can have a cross-section that increases continuously or in steps in the direction of flow or towards the discharge outlet 11. In particular, the discharge channel 10, at least in its axial channel portion 22, can be configured conically and enlarge towards the discharge opening 11.

The discharge channel 11 extends beyond the filtering device 9 or around it in the manner of a bypass. Viewed axially, the inlet port 12 and the discharge outlet 11 are located on opposite sides of the filtering device 9 in order to guide fluid to be discharged past the filtering device 9.

The transverse channel portion 21 is configured in the filter pin 7 in such a manner that the inlet port 12 opens in a sector of the filter pin 7 on its outer circumference, which in itself—more precisely when looking at the operating position according to FIG. 1 and/or when looking at the filter change position according to FIG. 2—is not in the same sector as the inlet channel 3, more precisely its opening into the pin receptacle 6. In other words, when the filter pin 7 is moved back and forth between the operating and filter change positions shown in FIGS. 1 and 2 by the axial drive 17, the inlet port 12 of the discharge channel 10 does not pass through the inlet channel 3 and does not come into flow communication with the inlet channel 3.

In order to bring the discharge channel 10 with the inlet port 12 into flow connection with the inlet channel 3 in a discharge position of the filter pin 7, which lies between its operating position and its filter change position, the filter pin 7 is rotated by a rotary drive 14 in the pin receptacle 6.

For this purpose, the filtering apparatus 1 comprises a rotary drive 14, which can have a pressure cylinder or adjustment actuator 16 arranged transversely to the longitudinal axis of the filter pin, the adjustment axis or direction of action of which can be aligned transversely to the longitudinal axis of the filter pin and, in particular, parallel to a tangent to the filter pin 7. For example, the adjustment actuator 16 of the rotary drive 14 can be arranged on the side of the axial drives 17 of the housing 2 and supported on the housing 2 and/or the bearing for the axial drives 17, in particular mounted in such a way that a working head of the adjustment actuator 16 can be moved past the piston rod of the axial drive 17 connected to it transversely to the longitudinal axis of the filter pin.

The rotary drive 14 can be releasably connected to the filter pin 7 by a coupling 24 in order to be able to couple the rotary drive 14 when the filter pin 7 is to be rotated into its starting position. On the other hand, the rotary drive 14 can be uncoupled by the coupling 24 in order to be able to move the filter pin 7 directly between the operating position and the filter change position without the influence of the rotary drive 14 and without a rotational component, as illustrated in FIGS. 1 and 2.

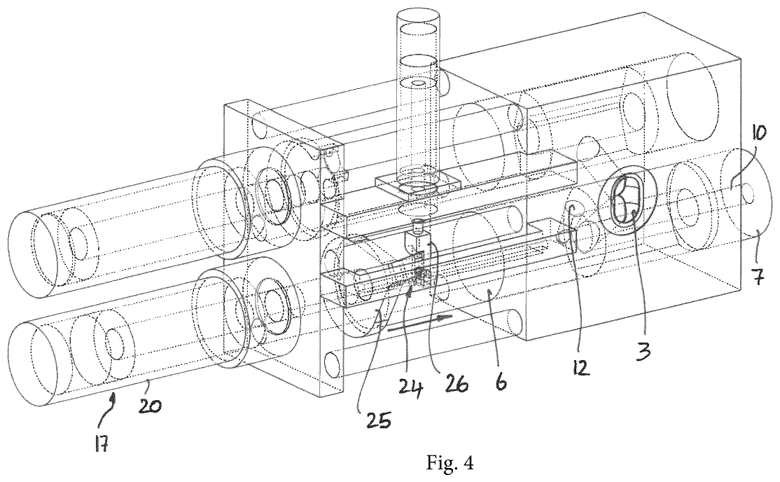

The coupling 24 can, for example, engage on a piston rod of the axial drive 17, which can be non-rotatably connected to the filter pin 7, wherein the coupling 24 can have a coupling piece 25 serving as a crank, which can be non-rotatably connected to the filter pin 7, in particular the piston rod non-rotatably connected there-to, and protrude transversely therefrom, cf. FIG. 3 and FIG. 4.

In order to couple the rotary drive 14 to the filter pin 7, the rotary drive 14 can first be extended into a coupling position in which the working head 26 of the rotary drive 14 reaches a position that is swept by the coupling piece 25 of the coupling 24 when the filter pin 7 is moved axially. The filter pin 7 can still be in the operating position when the rotary drive 14 is moved into its coupling position, cf. FIG. 3.

In order to couple the rotary drive 14, the axial drive 17 moves the filter pin 7 a little in the axial direction until the coupling piece 25 engages with the working head 26, cf. FIG. 4.

Advantageously, the coupling position of the filter pin 7 can be selected so that the inlet port 12 of the discharge channel 10 is already positioned to fit the inlet channel 3 when viewed axially, but is still rotationally offset from this, cf. FIG. 4.

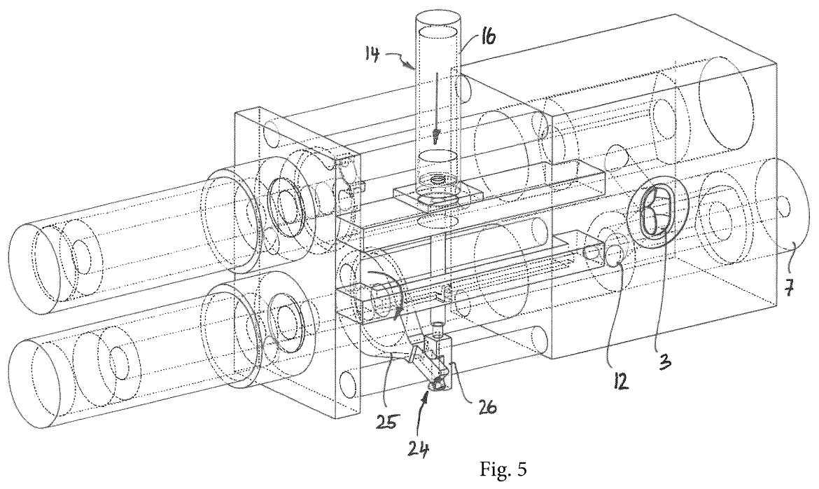

In order to bring the discharge channel 10 into flow connection with the inlet channel 3, the rotary drive 14 is then actuated to rotate the filter pin 7 until the inlet port 12 of the discharge channel 10 overlaps with the inlet channel 3, cf. FIG. 5.

In order to prevent the material to be discharged from flowing into the filtering device of the second filter pin 18 in the starting position, the filter pin 18 is moved axially into a blocking position in which the cylindrical end portion of the second filter pin 18 blocks the bifurcation of the inlet channel 3 leading into its pin receptacle 5, cf. FIG. 6.

If the filter pins 7 and 18 are in the starting position shown in FIGS. 6 and 7, the system can be started up, wherein any melt or fluid entering the filtering device 1 is discharged via the discharge channel 10 of the filter pin 7. The discharged material can flow out of the front discharge outlet 11 or drip off without contaminating the housing 2.

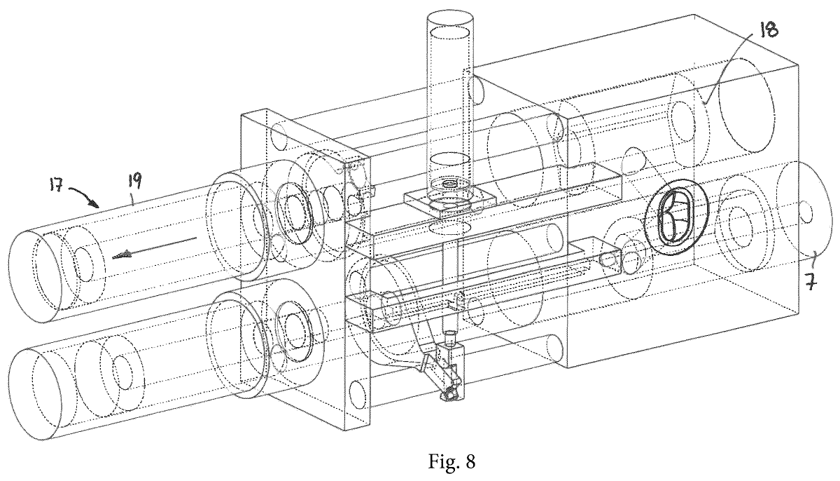

If the material is not suitable for further processing, the production process or the intended filtration can be started by moving the second filter pin 18 from its blocking position back into the operating position by the axial drive 17 pulling the filter pin 18 back or moving it back into the operating position, cf. FIG. 8. This allows the usable fluid to flow directly via the filtering device 9 of the second filter pin 18 and be fed to the outlet channel 4 and thus to the subsequent processing process.

At the same time or afterwards, the filter pin 7 can be moved away from its starting position by the rotary drive 14 first turning the filter pin 7 again until the discharge channel 10 is no longer flow-connected to the inlet channel 3. In particular, the rotary drive 14 can turn the filter pin 7 back again until the filtering device 9 is suitably rotationally aligned so that fluid coming from the inlet channel 3 can be filtered during the subsequent axial movement.

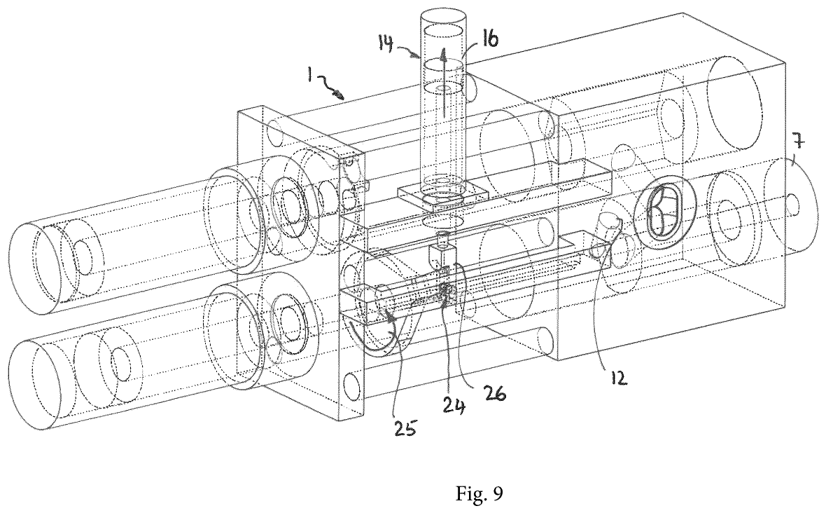

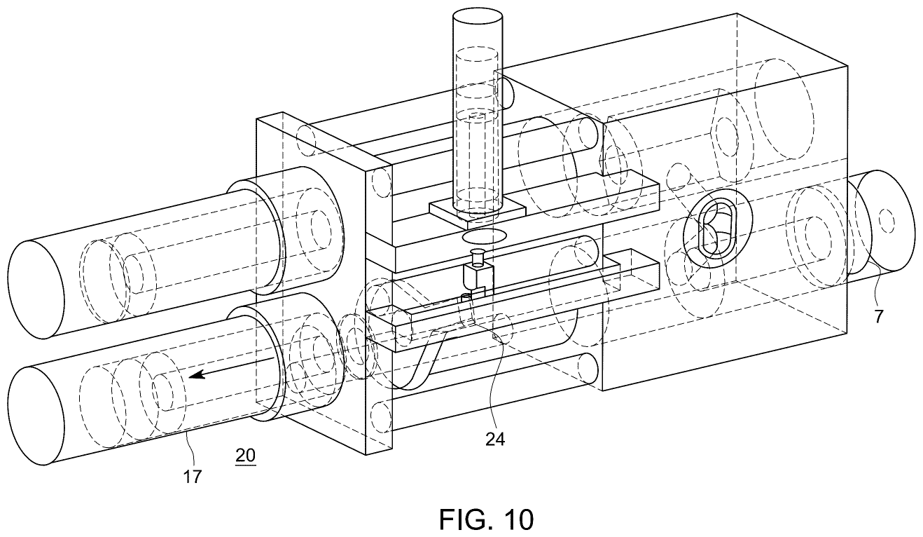

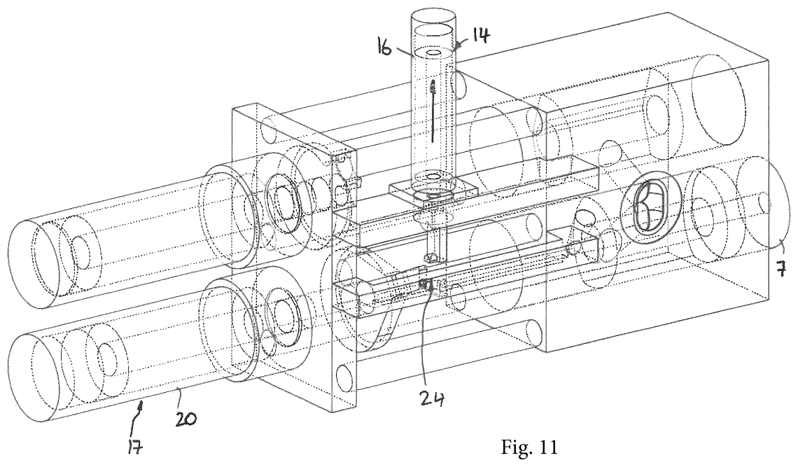

If the filter pin 7 is turned back, cf. FIG. 9, the axial drive 17 can move the filter pin 7 axially in order to release the coupling 24, cf. FIG. 10, whereupon the rotary drive 14 can then move back to its waiting position, cf. FIG. 11.

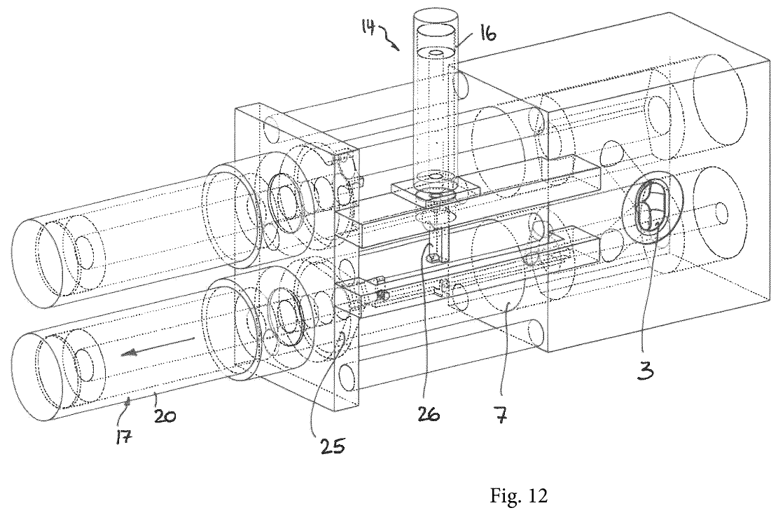

Finally, the filter pin 7 can be moved axially back into its operating position so that the material to be filtered can flow over both filter pins 7 and 18 again or be filtered by both filter pins 7 and 18, cf. FIG. 12. Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A filtering apparatus comprising:
a housing comprising:
an inlet channel; and
a pin receptacle; and
a filter pin comprising a discharge channel having an inlet port located on an outer circumference of the filter pin and configured to lie in a circumferential sector of the filter pin;
wherein:
the filter pin is configured to be received in an axially displaceable and rotatable manner in the pin receptacle of the housing;
the filter pin is further configured to assume different rotational positions in the pin receptacle of the housing, including an operating position and a starting position;
in the operating position of the filter pin, the inlet port of the discharge channel of the filter pin is rotationally offset relative to the inlet channel of the housing; and
in the starting position of the filter pin, the inlet port of the discharge channel of the filter pin is arranged so as to overlap with the inlet channel of the housing.

2. The filtering apparatus of claim 1, wherein:
the housing further comprises an outlet channel;
the filter pin further comprises:
a filter portion with a filtering device; and
a discharge outlet;
the filter pin is further configured to be arranged between the inlet and outlet channels of the housing;
in the operating position of the filter pin, the filtering device of the filter portion of the filter pin is configured to:
be arranged between the inlet and outlet channels of the housing; and
connect the inlet channel of the housing to the outlet channel of the housing, as well as the discharge channel of the filter pin; and
in the starting position of the filter pin:
the discharge channel of the filter pin is configured to be flow-connected to the inlet channel of the housing and lead past the filtering device of the filter portion of the filter pin to the discharge outlet of the filter pin.

3. The filtering apparatus of claim 1 further comprising:
a rotary drive for rotating the filter pin in the pin receptacle of the housing at least one of:
when the filter pin is axially stationary; or
independently of an axial adjustment of the filter pin.

4. The filtering apparatus of claim 1, wherein:
another rotational position of the filter pin in the pin receptacle of the housing is a filter change position;
in the filter change position of the filter pin, the filtering device of the filter portion of the filter pin is configured to be freely accessible for replacement and/or extended out of the housing axially; and
the filter pin is further configured to assume at least approximately the same rotational position in the operating position and in the filter change position.

5. A filtering apparatus comprising:
a housing comprising:
an inlet channel;
an outlet channel; and
a pin receptacle; and
a filter pin configured to be received in an axially displaceable and rotatable manner in the pin receptacle of the housing, the filter pin comprising:
a filter portion with a filtering device;
a discharge outlet; and
a discharge channel having an inlet port located on an outer circumference of the filter pin and configured to lie in a circumferential sector of the filter pin; and
a rotary drive for rotating the filter pin in the pin receptacle of the housing;
wherein:
the filter pin is further configured to:
be arranged between the inlet and outlet channels of the housing; and
assume different rotational positions in the pin receptacle of the housing, including an operating position, a starting position, and a filter change position;
in the operating position of the filter pin:
the filtering device of the filter portion of the filter pin is configured to be arranged between the inlet and outlet channels of the housing;
the filtering device of the filter portion of the filter pin is configured to connect the inlet channel of the housing to the outlet channel of the housing, as well as the discharge channel of the filter pin; and
the inlet port of the discharge channel of the filter pin is configured to be rotationally offset relative to the inlet channel of the housing; and
in the starting position of the filter pin:
the discharge channel of the filter pin is configured to be flow-connected to the inlet channel of the housing and lead past the filtering device of the filter portion of the filter pin to the discharge outlet of the filter pin; and
the inlet port of the discharge channel of the filter pin is configured to be arranged so as to overlap with the inlet channel of the housing.

6. The filtering apparatus of claim 5, wherein at least one of:
the rotary drive is configured for rotating the filter pin in the pin receptacle of the housing when the filter pin is axially stationary and/or independently of an axial adjustment of the filter pin;
the rotary drive is configured so as to be uncoupled from the filter pin, wherein the filter pin is configured to be axially movable between the operating position and filter change position when uncoupled from the rotary drive;
the filter pin is configured to be coupled to the rotary drive by axial displacement of the filter pin and uncoupled from the rotary drive, in such a manner that the rotary drive is moveable into a rotary drive coupling position in the operating position of the filter pin or in the filter change position of the filter pin, and the filter pin can subsequently be moved axially into a filter pin coupling position;
the rotary drive comprises an adjustment actuator with an effective direction oriented transversely to a longitudinal axis of the filter pin and at least approximately parallel to a tangent to the filter pin; or
the rotary drive and an axial drive configured for axial adjustment of the filter pin are arranged on the same side of the housing, wherein the rotary drive, viewed axially of the filter pin, is arranged between the housing and a pressure cylinder of the axial drive.

7. The filtering apparatus of claim 5, wherein:
in the filter change position of the filter pin, the filtering device of the filter portion of the filter pin is configured to be freely accessible for replacement and/or extended out of the housing axially; and
the filter pin is further configured to assume at least approximately the same rotational position in the operating position and in the filter change position.

8. The filtering apparatus of claim 5, wherein:
the starting position of the filter pin, viewed axially, lies between the operating position and the filter change position; and
an axial range of adjustment of the filter pin from the operating position into the starting position is shorter than from the starting position into the filter change position.

9. The filtering apparatus of claim 5, wherein the filter pin is further configured to be moveable from the operating position into the filter change position and/or from the filter change position into the operating position by axial displacement without turning and/or without approaching the rotational position of the starting position.

10. The filtering apparatus of claim 5, wherein a rotational offset of the filtering pin between the operating position and the starting position is at least one of:
between 20° and 120°;
between 30° and 90°; or
between 30° and 60°.

11. The filtering apparatus of claim 5, wherein the discharge outlet of the filter pin is arranged in an end portion of the filter pin that protrudes from the housing when in the starting position of the filter pin.

12. The filtering apparatus of claim 5, wherein at least one of:
the discharge channel of the filter pin opens with the discharge outlet of the filter pin on an end face of the filter pin;
in at least in the starting position of the filter pin, the discharge channel of the filter pin is configured in a continuously sloping manner up to the discharge outlet of the filter pin;
the discharge channel of the filter pin has a cross-section that increases continuously or in steps in a discharge direction; or
the discharge channel of the filter pin extends through an axial column that bridges the filter portion of the filter pin in an exposed manner.

13. The filtering apparatus of claim 5 further comprising:
a second filter pin configured to be axially displaceably received in a second pin receptacle in the housing;
wherein the inlet and outlet channels of the housing are each configured in a bifurcated manner, so that the inlet channel of the house is selectively flow-connected to the outlet channel of the housing either individually via each respective filter pin or both filter pins together.

14. The filtering apparatus of claim 6, wherein the same side of the housing is the side of the housing facing away from a housing side for filter replacement.

15. The filtering apparatus of claim 8, wherein in the starting position of the filter pin, the filtering device is still arranged within the housing.

16. The filtering apparatus of claim 12, wherein the discharge channel of the filter pin extends through the axial column that bridges the filter portion of the filter pin in the exposed manner and contains a longitudinal central axis of the filter pin.

17. The filtering apparatus of claim 13, wherein:
the filter pin different from the second filter pin is a first filter pin; and
the second filter pin has a second filter pin starting position in which the inlet channel of the housing is shut off from the outlet channel of the housing, and the inlet channel of the housing is flow-connected to surroundings of the housing only via the discharge channel of the first filter pin.

18. The filtering apparatus of claim 17 further comprising:
a control device configured for axial adjustment of the first and second filter pins in such a manner that, in order to set a filtering apparatus starting position of the filtering apparatus, the first filter pin is brought into the starting position by axial displacement and rotational adjustment, and the second filter pin is brought into the starting position solely by axial adjustment.
